(19) United States
(12) Patent Application Publication
(10) Pub. No.: US 2013/0015741 A1
(43) Pub. Date: Jan. 17, 2013

(54) TRANSVERSE SWITCHED RELUCTANCE MOTOR

(71) Applicants: Changsung Sean KIM, Gyunggi-do (KR); Chang Hwan CHOI, Gyunggi-do (KR); Han Kyung BAE, Gyunggi-do (KR); Guen Hong LEE, Seoul (KR)

(72) Inventors: Changsung Sean KIM, Gyunggi-do (KR); Chang Hwan CHOI, Gyunggi-do (KR); Han Kyung BAE, Gyunggi-do (KR); Guen Hong LEE, Seoul (KR)

(73) Assignee: SAMSUNG ELECTRO-MECHANICS CO., LTD., Gyunggi-do (KR)

(21) Appl. No.: 13/316,368

(22) Filed: Dec. 9, 2011

(30) Foreign Application Priority Data
Jul. 14, 2011 (KR) 10-2011-0070107

(51) Int. Cl. H02K 16/00

(52) U.S. Cl. 310/114

(57) ABSTRACT

Disclosed herein is a transverse switched reluctance motor including: a rotor including a plurality of rotor disks each having a shaft fixedly coupled to an inner portion thereof, having a plurality of rotor poles fixedly coupled thereto along an outer peripheral surface thereof, and arranged in a direction of a shaft; and a stator assembly including a plurality of stators each facing the plurality of rotor poles, having coils wound therearound, and arranged in a circumferential direction of the plurality of rotor disks so that the plurality of rotor disks are rotatably received therein, wherein magnetic flux paths are formed so that magnetic fluxes move in the direction of the shaft by the plurality of stators and the plurality of rotor poles facing the plurality of stators to circulate the stators.

### CROSS REFERENCE TO RELATED APPLICATION

This application claims the benefit of Korean Patent Application No. 10-2011-0070107, filed on Jul. 14, 2011, entitled “Transverse Type Switched Reluctance Motor”, which is hereby incorporated by reference in its entirety into this application.

### BACKGROUND OF THE INVENTION

1. Technical Field

The present invention relates to a transverse switched reluctance motor.

2. Description of the Related Art

Recently, a demand for a motor has largely increased in various industries such as vehicles, aerospace, military, medical equipment, or the like. In particular, a cost of a motor using a permanent magnet is increased due to the sudden price increase of a rare earth material, such that a switched reluctance motor (hereinafter, referred to as an SR motor) has become interested as a new alternative.

A driving principle of an SR motor rotates a rotor using a reluctance torque generated according to a change in magnetic reluctance.

Generally, the switched reluctance motor is configured to include a stator 10 including a plurality of fixing salient poles 11 and a rotor 20 including a plurality of rotating salient poles 22 facing the plurality of fixing salient poles 11 as shown in FIG. 1.

More specifically, the stator 10 is configured to include the plurality of fixing salient poles 11 protruded toward the rotor 20 at predetermined intervals in a circumferential direction of an inner peripheral surface of the stator 10 and coils 12 wound around each of the fixing salient poles 11.

The rotor 20 is formed by stacking cores 21 from which the plurality of rotating salient poles 22 facing the respective fixing salient poles 11 are protruded at predetermined intervals in a circumferential direction.

In addition, a shaft 30 transferring driving force of the motor to the outside is coupled to the center of the rotor 20 to thereby integrally rotate together with the rotor 20.

Further, a concentrated type coil 12 is wound around the fixing salient poles 11. On the other hand, the rotor 20 is configured of only an iron core without any type of excitation device, for example, a winding of a coil or a permanent magnet.

Therefore, when a current flows in the coil 12 from the outside, a reluctance torque to moving the rotor 20 toward the coil 12 by magnetic force generated from the coil 12 is generated, such that the rotor 20 rotates in a direction in which resistance of a magnetic circuit is minimized.

On the other hand, the SR motor according to the prior art may lead to core loss since a magnetic flux path passes through both of the stator 10 and the rotor 20.

In addition, driving force of the switched reluctance motor may be deteriorated due to the generation of the core loss.

### SUMMARY OF THE INVENTION

The present invention has been made in an effort to provide a transverse switched reluctance motor making a magnetic flux path short to reduce core loss.

Further, the present invention has been made in an effort to provide a transverse switched reluctance motor having improved driving force by including a rotor and a stator that may be stacked in plural and be easily extended.

According to a first preferred embodiment of the present invention, there is provided a transverse switched reluctance motor including: a rotor including a plurality of rotor disks each having a shaft fixedly coupled to an inner portion thereof, having a plurality of rotor poles fixedly coupled thereto along an outer peripheral surface thereof, and arranged in a direction of a shaft; and a stator assembly including a plurality of stators each facing the plurality of rotor poles, having coils wound therearound, and arranged in a circumferential direction of the plurality of rotor disks so that the plurality of rotor disks are rotatably received therein, wherein magnetic flux paths are formed so that magnetic fluxes move in the direction of the shaft by the plurality of stators and the plurality of rotor poles facing the plurality of stators to circulate the stators.

The stator may be formed by stacking a plurality of stator cores so as to face the rotor disks in a direction in which the rotor disks are stacked.

The stator core may include: a stator core body disposed at an outer side of the rotor disk and being in parallel with the rotor pole; a first stator salient pole bent and protruded from one end of the stator core body so as to face an upper surface of the rotor pole; and a second stator salient pole bent and protruded from the other end of the stator core body so as to face a lower surface of the rotor pole, wherein the stator core has a C shaped cross section in the direction of the shaft around which the rotor disk rotates.

In the stator, one side of a second stator salient pole configuring one stator core and one side of a first stator salient pole configuring another stator core may be coupled to each other, and the other side of the second stator salient pole and one side of a first stator salient pole configuring the other stator core may be coupled to each other, such that the stator cores are stacked stepwise.

One stator core and another stator core may further include a reinforcing member coupled between outer sides thereof.

The rotor disk may be rotatably received in an interval formed by the first and second stator salient poles.

The rotor may be configured of the plurality of rotor disks sequentially arranged to be spaced apart from each other at predetermined intervals in the direction of the shaft so that the first stator salient pole or the second stator salient pole configuring the stator core is received therein.

N rotor poles may be provided in the rotor disk and be arranged to be skewed, by a predetermined angle difference, from n rotor poles included in another rotor disk disposed to be spaced apart from the rotor disk by a predetermined interval.

The angle difference (θ) may correspond to 120°/n=degree according to the number (n) of rotor poles formed in the rotor disk.

According to a second preferred embodiment of the present invention, there is provided a transverse switched reluctance motor including: a rotor including a plurality of rotor disks each having a shaft fixedly coupled to an inner portion thereof, sequentially to arranged to be spaced apart from each other at predetermined intervals in a direction of the shaft, and having a plurality of rotor poles fixedly coupled thereto along an outer peripheral surface thereof; and a stator assembly including a plurality of stators each facing the plurality of rotor poles, having coils wound therearound, and arranged in a circumferential direction of the plurality of rotor disks so that the plurality of rotor disks are rotatably received therein, wherein magnetic flux paths are formed so that magnetic fluxes move in the direction of the shaft by the plurality of stators and the plurality of rotor poles facing the plurality of stators to circulate the stators.

The stator may include: a stator core disposed at an outer side of the rotor disk and being in parallel with the rotor pole; and a plurality of stator salient poles protruded from the stator core toward the rotor pole.

The number (m) of stator salient poles may be determined according to the number (m) of rotor disks.

According to a third preferred embodiment of the present invention, there is provided a transverse switched reluctance motor including: a rotor including a plurality of rotor disks each having a shaft fixedly coupled to an inner portion thereof, sequentially arranged to be spaced apart from each other at predetermined intervals in a direction of the shaft, and having a plurality of rotor poles fixedly coupled thereto along an outer peripheral surface thereof; and a stator assembly including a plurality of stators each facing the plurality of rotor poles, having coils wound therearound, and arranged in a circumferential direction of the plurality of rotor disks so that the plurality of rotor disks are rotatably received therein, wherein magnetic flux paths are formed so that magnetic fluxes move in the direction of the shaft by the plurality of stators and the plurality of rotor poles facing the plurality of stators to circulate the stators.

The stator may be formed by stacking a plurality of stator cores so as to face the rotor disks in a direction in which the rotor disks are stacked.

The stator core may include: a stator core body disposed at an outer side of the rotor to disk and being in parallel with the rotor pole; a first stator salient pole bent and protruded from one end of the stator core body so as to face an upper surface of the rotor pole provided in the rotor disk; and a second stator salient pole bent and protruded from the other end of the stator core body so as to face a lower surface of the rotor pole provided in the rotor disk, wherein the stator core has a C shaped cross section in the direction of the shaft around which the rotor disk rotates.

In the stator, one side of a second stator salient pole configuring one stator core and one side of a first stator salient pole configuring another stator core may be coupled to each other, and the other side of the second stator salient pole and one side of a first stator salient pole configuring the other stator core may be coupled to each other, such that the stator cores are stacked stepwise.

The stator may include: a stator core body disposed at an outer side of the rotor disk and being in parallel with the rotor pole; a plurality of stator salient poles bent and protruded from the stator core toward the rotor pole.

The number (m) of stator salient poles may be determined according to the number (m) of rotor disks.

### BRIEF DESCRIPTION OF THE DRAWINGS

FIG. 1 is a cross-sectional view of a switched reluctance motor according to the prior art;

FIG. 2 is a perspective view of a transverse switched reluctance motor according to a preferred embodiment of the present invention;

FIG. 3 is a schematic exploded perspective view of the transverse switched reluctance motor shown in FIG. 2;

FIG. 4 is a schematic assembly perspective view of a stator shown in FIG. 2;

FIGS. 5A to 5C are plan views schematically showing a method for driving the transverse switched reluctance motor shown in FIG. 2;

FIG. 6 is a state diagram schematically showing a flow of a magnetic flux of the transverse switched reluctance motor shown in FIG. 2;

FIG. 7 is a schematic exploded perspective view of a transverse switched reluctance motor according to another preferred embodiment of the present invention;

FIG. 8 is a state diagram schematically showing a flow of a magnetic flux of the transverse switched reluctance motor shown in FIG. 7;

FIG. 9 is a schematic exploded perspective view of a transverse switched reluctance motor according to another preferred embodiment of the present invention;

FIG. 10 is a state diagram schematically showing a flow of a magnetic flux of the transverse switched reluctance motor shown in FIG. 9;

FIG. 11 is a schematic exploded perspective view of a transverse switched reluctance motor including a modified stator according to another preferred embodiment of the present invention; and

FIG. 12 is a state diagram schematically showing a flow of a magnetic flux of the transverse switched reluctance motor shown in FIG. 11.

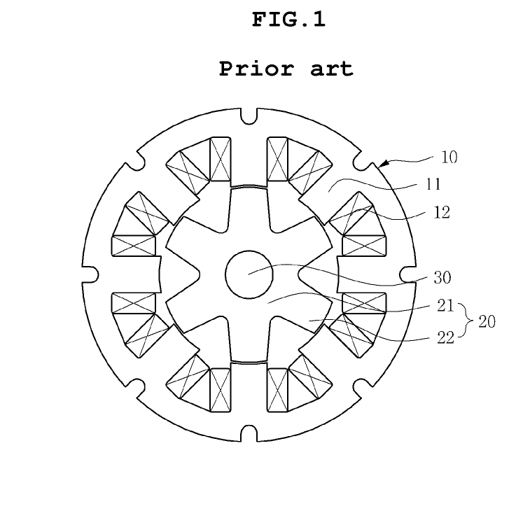

### DESCRIPTION OF THE PREFERRED EMBODIMENTS

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that to the detailed description of the known art related to the present invention may obscure the gist of the present invention, the detailed description thereof will be omitted.

Hereinafter, preferred embodiments of the present invention will be described in detail with reference to the accompanying drawings.

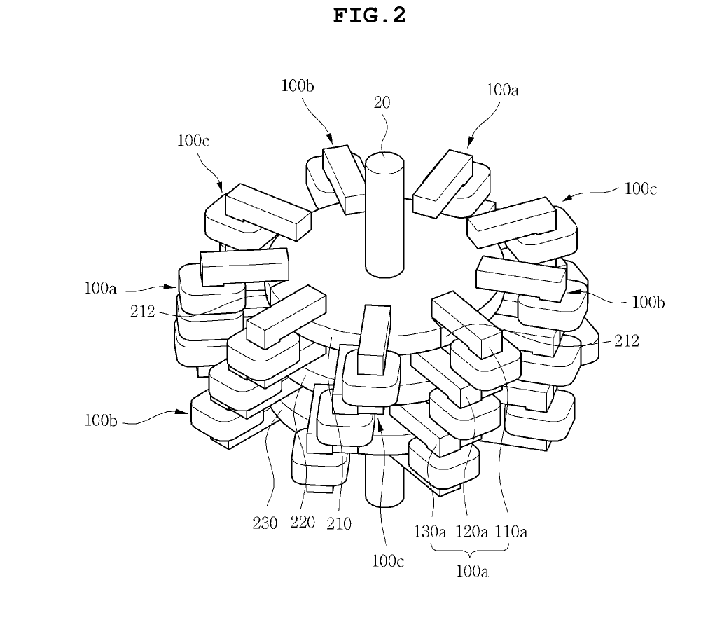

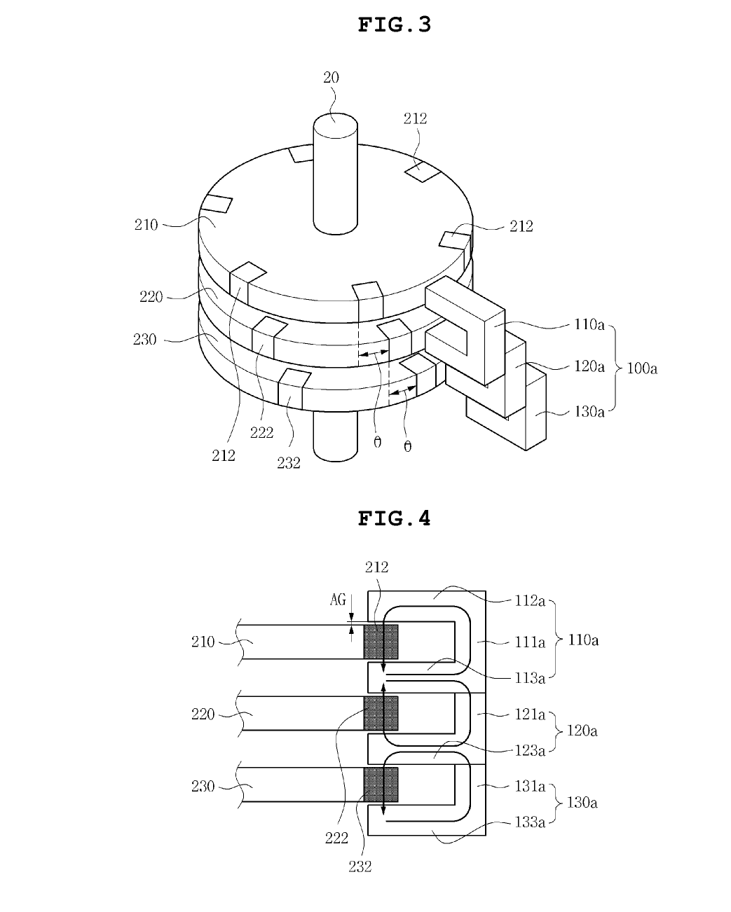

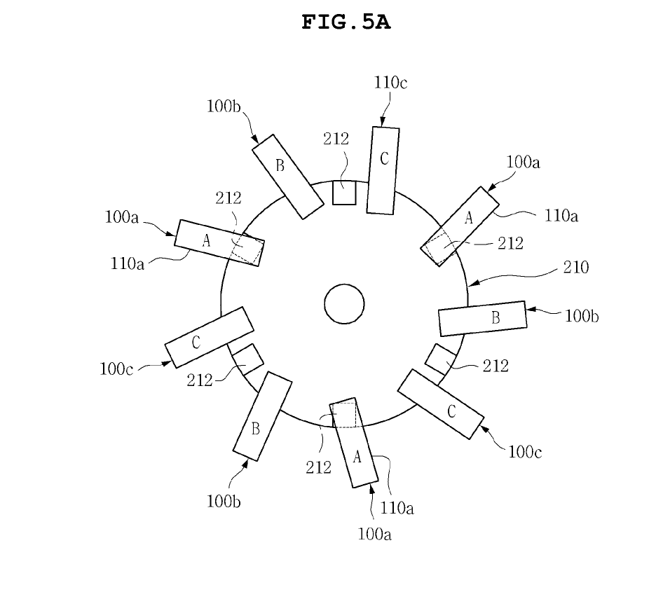

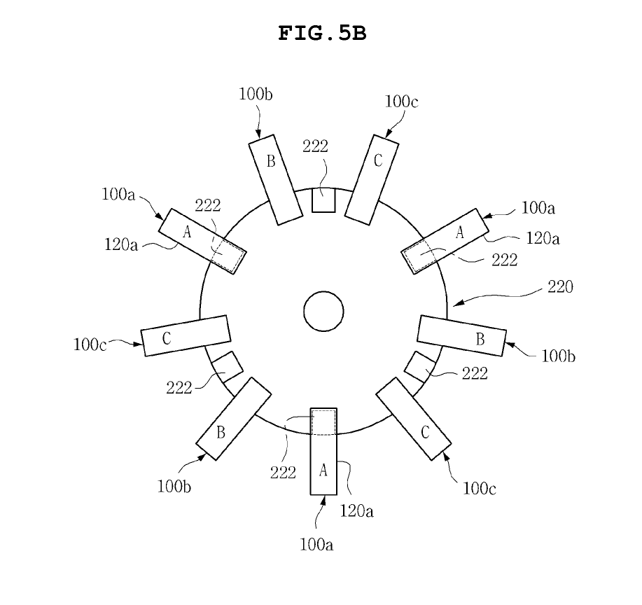

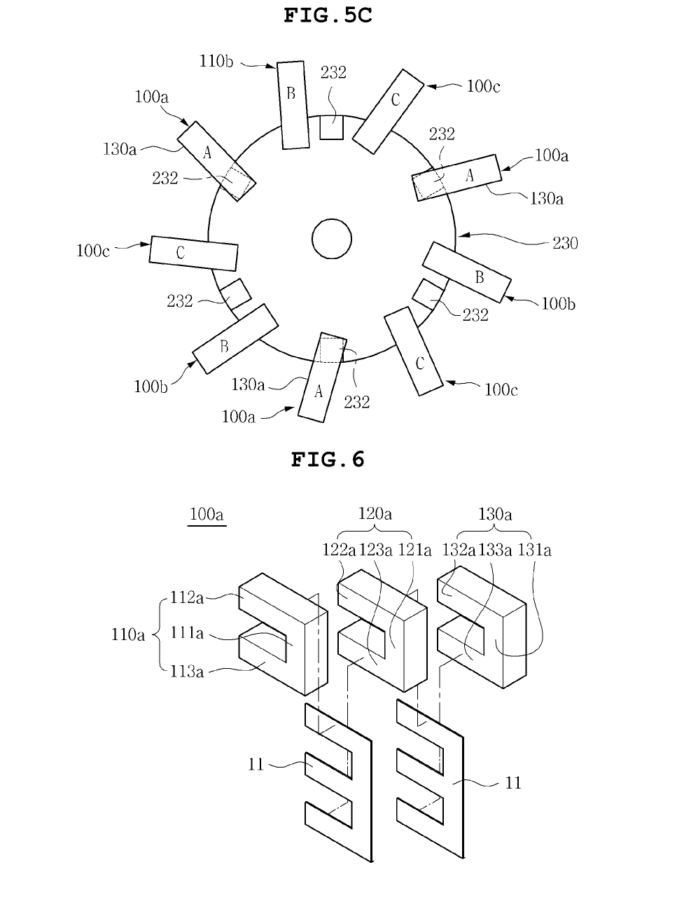

FIG. 2 is a perspective view of a transverse switched reluctance motor according to a preferred embodiment of the present invention; FIG. 3 is a schematic exploded perspective view of the transverse switched reluctance motor shown in FIG. 2; FIG. 4 is a schematic assembly perspective view of a stator shown in FIG. 2; FIGS. 5A to 5C are plan views schematically showing a method for driving the transverse switched reluctance motor shown in FIG. 2; and FIG. 6 is a state diagram schematically showing a flow of a magnetic flux of the transverse switched reluctance motor shown in FIG. 2.

As shown, a transverse switched reluctance motor according to a preferred embodiment of the present invention includes a stator assembly and a rotor rotating in one direction by a reluctance torque generated by magnetic force with the stator assembly.

More specifically, the rotor includes a plurality of rotor disks 210, 220, and 230 each including a plurality of rotor poles 212 coupled thereto along an outer peripheral surface thereof.

In addition, the respective rotor disks 210, 220, and 230 may be sequentially arranged to be spaced apart from each other by predetermined intervals.

Further, the rotor disks 210, 220, and 230 have a hollow hole formed at the center thereof, wherein the hollow hole has a shaft 20 fixedly coupled thereto and the shaft 20 transfers rotational force of the motor to the outside. In addition, the rotor pole 212 is formed by stacking several sheets of iron core panels made of a metal material in a direction of the shaft 20. According to the preferred embodiment of the present invention, the rotor pole 212 may have a rectangular parallelepiped shape.

Therefore, a plurality of rotor pole mounting grooves including the rotor poles 121 fixedly coupled thereto are formed along an outer peripheral surface of the rotor disk, wherein the number of rotor pole mounting grooves corresponds to that of rotor poles 212.

As shown, the stator assembly includes a plurality of stators 100a, 100b, and 100c arranged in a circumferential direction of the plurality of rotor disks 210, 220, and 230 so that the plurality of rotor disks 210, 220, and 230 are rotatably received therein.

More specifically, the plurality of stators 100a, 100b, and 100c are arranged to form a cylindrical shape in an outer diameter direction of the rotor, thereby rotatably receiving the rotor therein.

In addition, since the preferred embodiment of the present invention is to implement a three-phase transverse switched reluctance motor, in order to form a single-phase, three stators form a single pair, as shown.

Therefore, in order to form a three-phase according to the preferred embodiment of the present invention, a total of nine stators are arranged in the outer diameter direction of the rotor, as shown in FIG. 2.

More specifically, a total of nine stators including three stators 100a forming an A phase, three stators 100b forming a B phase, and three stators 100c forming a C phase, configure the stator assembly.

In addition, according to the preferred embodiment of the present invention, three stators 100a, 100a, and 100a forming a single-phase may have an angle of 120° formed therebetween based on the shaft 20.

Further, as shown in FIGS. 2 and 3, the stator 100a is formed by stacking a plurality of stator cores 110a, 120a, and 130a in the direction of the shaft 20, which is a direction in which the plurality of rotor disks 210, 220, and 230 are stacked, so as to face the plurality of rotor poles 212, 222, and 232 provided in each of the rotor disks 210, 220, and 230.

That is, as shown in FIGS. 3 and 4, the stator core 110a includes a stator core body 111a, a first stator salient pole 112a, and a second stator salient pole 113a.

More specifically, the stator core body 111a is disposed at an outer side of the rotor to disk 210 so as to be spaced apart from the rotor pole 212 by a predetermined interval and be in parallel with the rotor pole 212.

In addition, the first stator salient pole 112a is bent and protruded from one end of the stator core body 111a so as to face an upper surface of the rotor pole 212 provided in the rotor disk 210.

In addition, the second stator salient pole 113a is bent and protruded from a lower end of the stator core body 111a so as to face a lower surface of the rotor pole 212 provided in the rotor disk 210.

In addition, the upper surface of the rotor pole 212 and the first stator salient pole 112a are spaced apart from each other by a predetermined interval, and the lower surface of the rotor pole 212 and the second stator salient 113a are also spaced apart from each other by a predetermined interval, such that two air gaps (AGs) are formed on the upper and lower surfaces of the rotor pole 212.

Therefore, the rotor disk 210 is rotatably received in an interval by the first and second stator salient poles 112a and 113a.

In addition, an area of the stator core body 111a between the first and second stator salient poles 112a and 113a includes coils 10 wound multiple times therearound, wherein the coil 10 has a power applied from the outside thereto.

Further, as shown in FIGS. 2 to 4, the stator 100a is formed by stacking the plurality of stator cores 110a, 120a, and 130a.

According to the preferred embodiment of the present invention, the stator 100a is formed by stacking three stator cores 110a, 120a, and 130a. More specifically, a first stator salient pole 122a configuring another stator core 120a is coupled to an outer side of a second stator salient pole 113a configuring one stator core 110a, such that the stator cores are stacked stepwise.

Therefore, a cross section in a direction of the shaft around which the rotor rotates has an E shape.

In addition, a first stator salient pole 132a configuring the other stator core 130a is coupled to an outer side of a second stator salient pole 123a configuring another stator core 120a, such that the stator cores are stacked stepwise.

Further, as shown in FIG. 4, according to the preferred embodiment of the present invention, the stator 100a includes the plurality of stator cores 110a, 120a, and 130a that are stacked stepwise. Here, a reinforcing member 11 is coupled between an outer side of one stator core 110a and an outer side of another stator core 120a to thereby improve adhesion between the stator cores 110a, 120a, and 130a.

In addition, according to the preferred embodiment of the present invention, the number of stacked stator cores configuring the stator is determined by the number of stacked rotor disks.

More specifically, according to the preferred embodiment of the present invention shown in FIGS. 2 to 5C, three rotor disks 210, 220, and 230 are stacked to thereby form the rotor.

Therefore, one stator 100a is formed by stacking three stator cores 110a, 120a, and 130a.

That is, as described above, one side of the second stator salient pole 113a configuring the stator core 110a and one side of the first stator salient pole 122a configuring another stator core 120a are coupled to each other.

In addition, one side of the first stator salient pole 132a configuring the other stator core 130a and the other side of the second stator salient pole 123a configuring another stator core 120a are coupled to each other.

Therefore, a total of three stator cores 110a, 120a, and 130a are coupled to each other in a stepped stacking scheme.

That is, according to the preferred embodiment of the present invention, one stator 100a facing the rotor formed by stacking three rotor disks 210a, 220a, and 230a includes a total of four stator salient poles.

In addition, since the number of stacked rotor disks may be variously changed and the number of stacked stator cores may also be variously changed, the transverse switched reluctance motor according to the preferred embodiment of the present invention has easy extendibility.

Further, as shown in FIG. 2, the plurality of rotor poles 212 provided in one rotor disk 210 the plurality of rotor poles 222 provided in another rotor disk 220 are arranged along outer peripheral surfaces of each of the rotor disks 210 and 220 in a state in which they are skewed from each other by a predetermined angle difference (θ).

More specifically, according to the preferred embodiment of the present invention, one rotor disk 210 includes six rotor poles 212 arranged thereon.

In addition, another rotor disk 220 also includes six rotor poles 222 arranged thereon, wherein the rotor pole 222 and the rotor pole 212 of the rotor disk 210 that has been previously arranged has an angle difference of 20° therebetween.

That is, similar to the extendibility of the rotor disk and the stator core described above, the plurality of rotor poles 212, 222, and 232 arranged in the rotor disks 210, 220, and 230 also have various extendibility.

More specifically, the angle difference (θ) between the rotor pole 121 arranged in one rotor disk 210 and the rotor pole 222 arranged in another rotor disk 220 corresponds to 120°/n=degree according to the number (n) of rotor poles formed in the rotor disks.

That is, when the angle difference is 30°, the number of rotor poles arrange in a single rotor disk is 4, when the angle difference is 20°, the number of rotor poles arrange in a single rotor disk is 6, when the angle difference is 15°, the number of rotor poles arrange in a single rotor disk is 8, and when the angle difference is 12°, the number of rotor poles arrange in a single rotor disk is 10, and so on. As a result, the rotor pole may be variously extended.

As shown in FIGS. 5A and 5C, when a power is applied from the outside to the coils 10 wound around the respective stator core bodies 111a, 121a, and 131a forming the A phase, a reluctance torque is generated according to a change in magnetic reluctance.

Then, the plurality of rotor disks received between the respective first and second stator salient poles rotate in a direction toward the first and second stator salient poles that are closest to the rotor pole.

More specifically, describing a first rotor disk 210 as shown in FIG. 5A, the first rotor disk 210 moves so that upper and lower surfaces of the rotor pole 212 arranged in the first rotor disk 210 face positions of first and second stator salient poles 112a and 113a of a first stator core 110a forming the A phase.

In addition, describing a second rotor disk 220 as shown in FIG. 5B, the second rotor disk 220 moves so that upper and lower surfaces of the rotor pole 222 arranged in the second rotor disk 220 face positions of first and second stator salient poles 122a and 123a of a second stator core 120a forming the A phase.

More specifically, the second rotor disk 220 moves so that the upper surface of the rotor pole 222 provided in the second rotor disk 220 faces the position of the first stator salient pole 122a of the second stator core 120a coupled to one side of the second stator salient pole 113a configuring the first stator core 110a and the lower surface of the rotor pole 222 faces the position of the second stator salient pole 123a.

In addition, describing a third rotor disk 230 as shown in FIG. 5C, the third rotor disk 230 moves so that upper and lower surfaces of the rotor pole 232 arranged in the third rotor disk 230 face positions of first and second stator salient poles 132a and 133a of a third stator core 130a forming the A phase.

More specifically, the third rotor disk 230 moves so that the upper surface of the rotor pole 232 provided in the third rotor disk 230 faces the position of the first stator salient pole 132a of the third stator core 130a coupled to the other side of the second stator salient pole 123a configuring the second stator core 120a and the lower surface of the rotor pole 232 faces the position of the second stator salient pole 133a.

Here, when the power is simultaneously applied to the coils 10 wound around the plurality of stator core bodies 111a, 121a, and 131a, magnetic fluxes flowing in the plurality of stator cores 110a, 120a, and 130a and the plurality of rotor poles 212, 222, and 232 pass through the stator 100a in which a cross section in the direction of the shaft 20 continuously has C shapes, as shown in FIG. 6.

More specifically, according to the preferred embodiment of the present invention, providing a description based on the first rotor disk 210 as shown, the magnetic flux flows in the first stator core 110a and a portion of the second stator core 120a.

More specifically, the magnetic flux sequentially passes through the stator core body 111a configuring the first stator core 110a, the first stator salient pole 112a, the rotor pole 212 provided in the first rotor disk 210, the second stator salient pole 113a configuring the first stator core 110a, and the first stator salient pole 122a configuring the second stator core 120a and coupled to one side of the second stator core 113a.

Then, according to the preferred embodiment of the present invention, since the stator 110a is stacked stepwise, providing a description based on the second rotor disk 220, the magnetic flux flows in a portion of the first stator core 110a, the second stator core 120, and a portion of the third stator core 130a.

More specifically, the magnetic flux sequentially passes through the stator core body 121a configuring the second stator core 120a, the second stator salient pole 113a configuring the first stator core 110a and the first stator salient pole 122a configuring the second stator core 120a, the rotor pole 222 provided in the second rotor disk 220, and the second stator salient pole 123a configuring the second stator core 120a and the first stator salient pole 132a configuring the third stator core 130a.

Further, describing the third rotor disk 230, the magnetic flux flows in a portion of the second stator core 120a and the third stator core 130a.

More specifically, the magnetic flux sequentially passes through the stator core body 131a configuring the third stator core 130a, the second stator salient pole 123a configuring the second stator core 120a and the first stator salient pole 132a configuring the third stator core 130a, the rotor pole 232 provided in the third rotor disk 230, and the second stator salient pole 133a configuring the third stator core 130a.

Therefore, as shown in FIGS. 5A to 5C, when the power is simultaneously applied to the coils 10 wound around the respective stator core bodies 111a, 121a, and 131a forming the A phase, three rotor disks 210, 220, and 230 simultaneously moves toward the respective first and second salient poles facing the plurality of rotor poles 212, 222, and 232.

Therefore, it is possible to allow the magnetic flux to move in the direction of the shaft, that is, a transverse direction so that a magnetic flux path becomes shorter than that of the switched reluctance motor according to the prior art.

As a result, the magnetic path is shortened by the stator 100a in which the cross section in the direction of the shaft continuously has the C shapes and the plurality of rotor poles 212, 222, and 232 facing the stator 100a, thereby making it possible to reduce core loss as compared to the switched reluctance motor according to the prior art.

In addition, it is possible to configure the rotor including the plurality of rotor disks and the stator assembly including the plurality of stators as a set module of a single transverse switched reluctance motor.

Therefore, it is possible to stack a set module of another transverse switched reluctance motor having the same configuration in the direction of the shaft 20.

As a result, it is possible to extend the transversal switched reluctance motor so as to be appropriate for the magnitude of a torque demanded by a component having the transverse switched reluctance motor mounted therein.

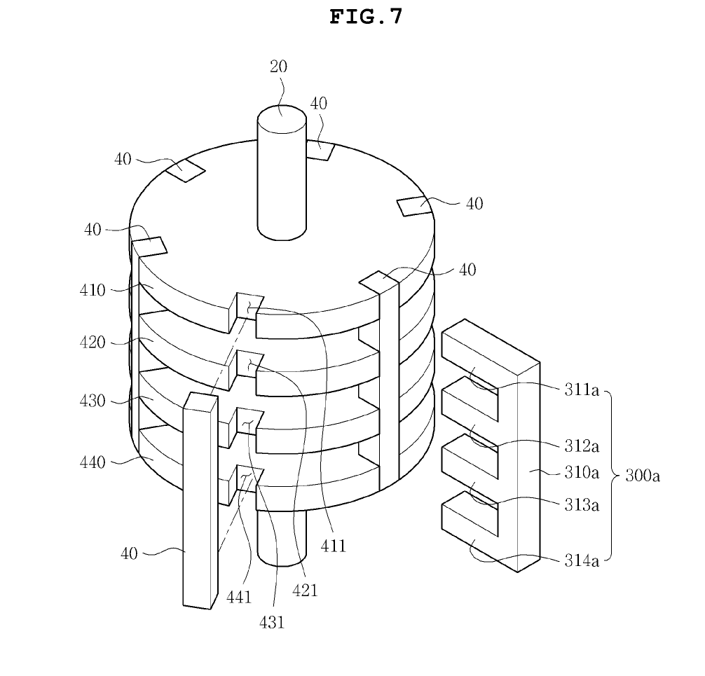

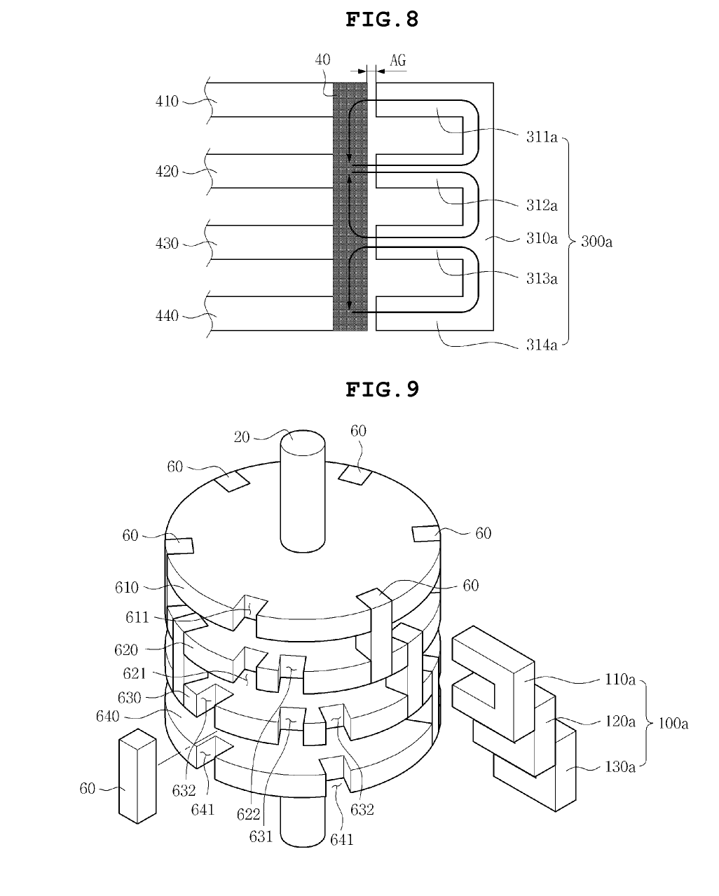

FIG. 7 is a schematic exploded perspective view of a transverse switched reluctance motor according to another preferred embodiment of the present invention; and FIG. 8 is a state diagram schematically showing a flow of a magnetic flux of the transverse switched reluctance motor shown in FIG. 7. In describing the present embodiment, the same or corresponding components to the foregoing preferred embodiments are denoted by the same reference numerals and therefore, the description of the overlapping portions will be to omitted. Hereinafter, a transverse switched reluctance motor according to the present embodiment will be described with reference to FIGS. 7 and 8.

As shown, a transverse switched reluctance motor according to another preferred embodiment of the present invention includes a stator assembly and a rotor rotating in one direction by a reluctance torque generated by magnetic force with the stator assembly.

The rotor includes a plurality of rotor disks 410, 420, 430, and 440 that are arranged to be spaced apart from each other by predetermined intervals and a plurality of rotor poles 40 each arranged along outer peripheral surfaces of the plurality of rotor disks 410, 420, 430, and 440.

More specifically, according to another preferred embodiment of the present invention, positions of a plurality of rotor pole mounting grooves 411, 421, 431, and 441 each formed in outer peripheral surfaces of the plurality of rotor disks 410, 420, 430, and 440 are the same in all of first to fourth rotor disks 410, 420, 430, and 440.

In addition, a length of the rotor pole is determined to be the same as a length from one end of the rotor to the other end thereof by the number of stacked rotor disks according to another preferred embodiment of the present invention. Further, as shown, the plurality of rotor poles 40 may have a bar shape in which they are in parallel with the shaft 20.

As shown, according to another preferred embodiment of the present invention, the rotor is formed by stacking four rotor disks 410, 420, 430, and 440, and the rotor pole mounting grooves 411, 421, 431, and 441 that are formed in the same positions in each of the first to fourth rotor disks 410, 420, 430, and 440 include the rotor pole 40 fixedly coupled thereto.

In addition, all of a plurality of stators configuring the stator assembly have the same shape.

Further, the stator assembly includes the plurality of stators arranged in a circumferential direction of the plurality of rotor disks 410, 420, 430, and 440 so that the plurality of rotor disks 410, 420, 430, and 440 are rotatably received therein. Only a single to stator 300a is shown in FIG. 7 in order to simplify the stator assembly.

In addition, the single stator 300a includes a stator core 310a and a plurality of stator salient poles 311a, 312a, 313a, and 314a.

More specifically, the stator core 310a is disposed at an outer side of the rotor so as to be in parallel with the rotor pole 40 and be spaced apart from the rotor pole 40 by a predetermined interval.

In addition, the plurality of stator salient poles 311a, 312a, 313a, and 314a are protruded from the stator core 310a toward the rotor pole 40.

In addition, an area of the stator core between one stator salient pole 311a and another stator salient pole 312a includes coils wound multiple times therearound, wherein the coil 10 has a power applied from the outside thereto.

Further, as shown in FIG. 8, the plurality of stator salient poles 311a, 312a, 313a, and 314a and the rotor pole 40 facing the plurality of stator salient poles 311a, 312a, 313a, and 314a are spaced apart from each other by a predetermined interval, such that an air gap (AG) is formed therebetween.

In addition, according to another preferred embodiment of the present invention, the number of stator salient poles is determined according to the number (m) of stacked rotor disks.

That is, as shown in FIG. 7, since the rotor is formed by stacking four rotor disks 410, 420, 430, and 440, the stator 300a includes four stator salient poles 311a, 312a, 313a, and 314a that face outer sides of the respective rotor disks 410, 420, 430, and 440.

That is, a first rotor disk 410 faces a first stator salient pole 311a, and a second rotor disk 420 faces a second stator salient pole 312a.

In addition, according to another preferred embodiment of the present invention, a magnetic flux flowing in the stator 300a and the rotor pole 40 passes through the stator core 310 including the coils wound therearound, the plurality of stator salient poles 311a, 312a, 313a, and 314a, and the rotor pole 40 having the bar shape, as shown in FIG. 8.

That is, as shown, when the power is simultaneously applied to the coils wound around the stator cores 310a forming a single-phase three rotor disks simultaneously move toward the plurality of stator salient poles 311a, 312a, 313a, and 314a facing the rotor pole 40.

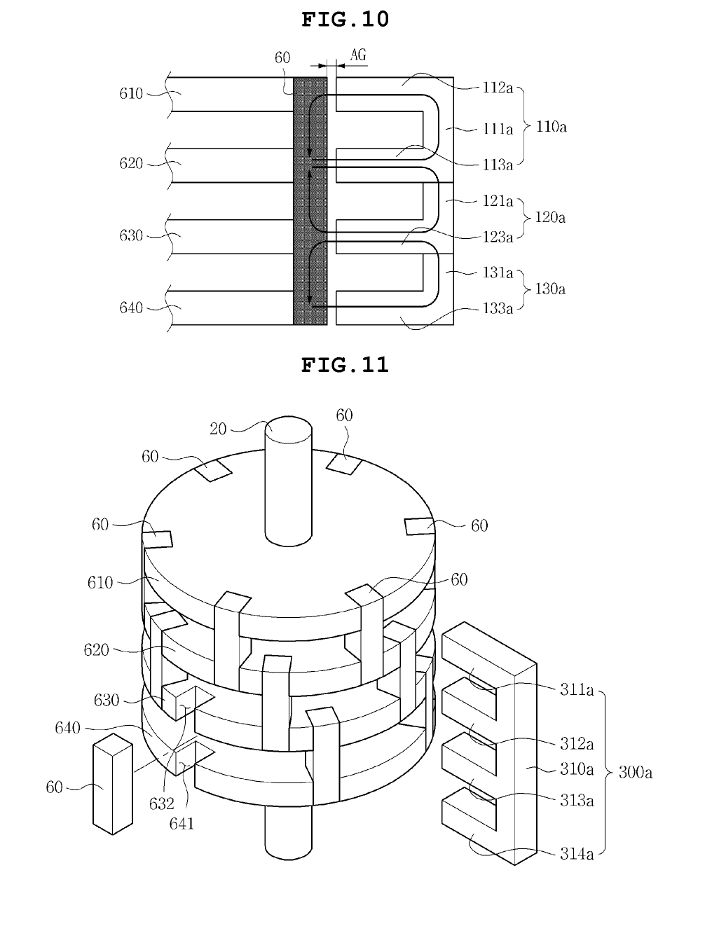

FIG. 9 is a schematic exploded perspective view of a transverse switched reluctance motor according to another preferred embodiment of the present invention; and FIG. 10 is a state diagram schematically showing a flow of a magnetic flux of the transverse switched reluctance motor shown in FIG. 9. In describing the present embodiment, the same or corresponding components to the foregoing preferred embodiments are denoted by the same reference numerals and therefore, the description of the overlapping portions will be omitted. Hereinafter, a transverse switched reluctance motor according to the present embodiment will be described with reference to FIGS. 9 and 10.

As shown, a transverse switched reluctance motor according to another preferred embodiment of the present invention includes a stator assembly and a rotor rotating in one direction by a reluctance torque generated by magnetic force with the stator assembly.

The rotor includes a plurality of rotor disks 610, 620, 630, and 640 that are arranged to be spaced apart from each other by predetermined intervals and a plurality of rotor poles 60 each arranged along outer peripheral surfaces of the plurality of rotor disks 610, 620, 630, and 640.

That is, according to another preferred embodiment of the present invention, each of the rotor disks includes a plurality of rotor pole mounting grooves 611, 621, 622, 631, 632, and 641 formed at an outer peripheral surface thereof. More specifically, as shown, a single rotor pole 60 is coupled to two rotor disks.

That is, providing a description based on first and second rotor disks 610 and 620, the rotor pole mounting groove 611 formed in the first rotor disk 610 and the rotor pole mounting groove 622 formed in the second rotor disk 620 are disposed to be skewed from each other by a predetermined angle difference, similar to the preferred embodiment of the present invention.

Additionally, the second rotor disk 620 includes the rotor mounting groove 621 formed at an outer peripheral surface thereof at a position facing the rotor pole mounting groove 611 formed in the first rotor disk 610.

More specifically, the remaining rotor disks 620 and 630 arranged in intermediate layers except for the first and final rotor disks 610 and 640 include the rotor pole mounting grooves formed therein so as to be skewed from the rotor pole mounting grooves of the previous rotor disks by a predetermined angle difference.

Additionally, the rotor disks arranged in the intermediate layers also include the rotor pole mounting grooves formed in positions thereof facing the rotor pole mounting grooves of the previous rotor disks.

That is, the number of rotor pole mounting grooves formed in the rotor disks arranged in the intermediate layers is double (2n) as compared to the number (n) of rotor pole mounting grooves formed in the first and final rotor disks.

Therefore, the rotor pole 60 connecting the first and second rotor disks 610 and 620 to each other and the rotor pole 60 connecting the second and third rotor disks 620 and 630 to each other are disposed to be skewed from each other by a predetermined angle difference.

In addition, all of a plurality of stators configuring the stator assembly have the same shape.

Further, the stator assembly includes the plurality of stators arranged in a circumferential direction of the plurality of rotor disks 610, 620, 630, and 640 so that the plurality of rotor disks 610, 620, 630, and 640 are rotatably received therein. Only a single stator 100a formed by stacking a plurality of stator cores 110a, 120a, and 130a is shown in FIG. 9 in order to simplify the stator assembly.

More specifically, the stator core 110a includes a stator core body 111a, a first stator salient pole 112a, and a second stator salient pole 113a, similar to the stator core according to the preferred embodiment of the present invention.

Therefore, as shown in FIG. 9, a first stator core 110a faces the rotor pole 60 connecting the first and second rotor disks 610 and 620 to each other.

More specifically, the first stator salient pole 112a faces a side of the rotor pole 60 disposed in the first rotor disk 610, and the second stator salient pole 113a faces a side of the rotor pole 60 disposed in the second rotor disk 620.

In addition, a second stator core 120a faces the rotor pole 60 connecting the second and third rotor disks 620 and 630 to each other.

More specifically, a first stator salient pole 122a of the second stator core 120a coupled to one side of the second stator salient pole 113a of the first stator core 110a faces a side of the rotor pole 60 disposed in the second rotor disk 620, and a second stator salient pole 123a of the second stator core 120a faces a side of the rotor pole 60 disposed in the third rotor disk 630.

In addition, a third stator core 130a faces the rotor pole 40 connecting the third and fourth rotor disks 630 and 640 to each other.

More specifically, a first stator salient pole 132a of the third stator core 130a coupled to the other side of the second stator salient pole 123a of the second stator core 120a faces a side of the rotor pole 60 disposed in the third rotor disk 630, and a second stator salient pole 133a of the third stator core 130a faces a side of the rotor pole 60 disposed in the fourth rotor disk 640.

In addition, according to another preferred embodiment of the present invention, a magnetic flux of the stator 110a and the rotor pole 60 passes through the plurality of stator cores 110a, 120a, and 130a and the rotor pole 60 facing the plurality of stator cores 110a, 120a, and 130a, connecting each of the plurality of rotor disks 610, 620, 630, and 640 to each other, and having the bar shape, as shown in FIG. 10.

That is, as shown, when the power is simultaneously applied to the coils wound around the stator cores 110a forming a single-phase, four rotor disks 610, 620, 630, and 640 to simultaneously move toward the respective first stator salient poles 112a, 122a, and 132a and second stator salient poles 113a, 123a, and 133a protruded from the stator cores 110a, 120a, and 130a facing the rotor pole 60.

Therefore, magnetic force generated in the coils wound around the stator core bodies are more uniformly distributed than magnetic force generated in the coils of the switched reluctance motor according to the prior art, thereby making it possible to prevent a reluctance torque from instantly appearing or disappearing.

That is, a torque ripple generated due to a sudden change in a reluctance torque is prevented, such that vibration of the rotor is reduced, thereby making it possible to reduce vibration noise generated in the motor.

In addition, the vibration is not generated in the rotor, thereby making it possible to prevent a malfunction of the motor in advance.

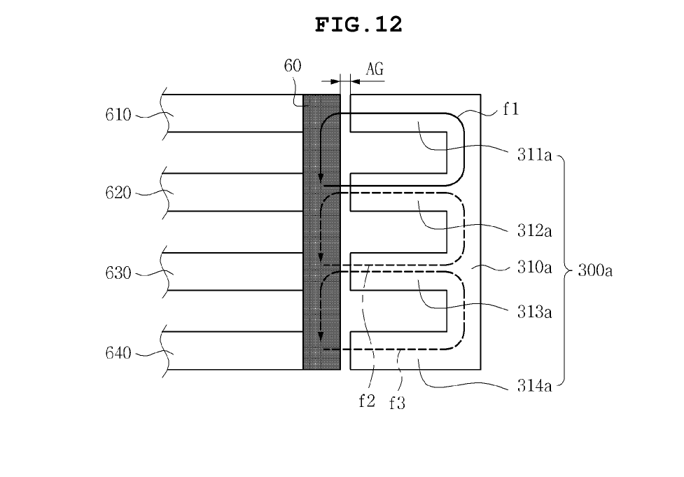

FIG. 11 is a schematic exploded perspective view of a transverse switched reluctance motor including a modified stator according to another preferred embodiment of the present invention; and FIG. 12 is a state diagram schematically showing a flow of a magnetic flux of the transverse switched reluctance motor shown in FIG. 11. In describing the present embodiment, the same or corresponding components to the foregoing preferred embodiments are denoted by the same reference numerals and therefore, the description of the overlapping portions will be omitted. Hereinafter, a transverse switched reluctance motor according to the present embodiment will be described with reference to FIGS. 11 and 12.

A stator assembly according to another preferred embodiment of the present invention is the same as the stator assembly according to the preferred embodiment of the present invention described with reference to FIGS. 7 and 8.

That is, all of a plurality of stators configuring the stator assembly have the same shape.

Further, the stator assembly includes the plurality of stators arranged in a to circumferential direction of the plurality of rotor disks 610, 620, 630, and 640 so that the plurality of rotor disks 610, 620, 630, and 640 are rotatably received therein. Only a single stator 300a is shown in FIG. 11 in order to simplify the stator assembly.

In addition, the single stator 300a includes a stator core 310a and a plurality of stator salient poles 311a, 312a, 313a, and 314a.

More specifically, the stator core 310a is disposed at an outer side of the rotor so as to be in parallel with the rotor pole 60 and be spaced apart from the rotor pole 60 by a predetermined interval.

In addition, the plurality of stator salient poles 311a, 312a, 313a, and 314a are protruded from the stator core 310a toward the rotor pole 60.

Therefore, a flow of a magnetic flux flowing in the stator 300a according to another preferred embodiment of the present invention and the rotor pole 60 connecting two rotor disks to each other is as follows as described in FIG. 12.

When the power is applied to a first coil wound between first and second stator salient poles 311a and 312a, a magnetic flux f1 shown in a solid line flows from an area of the stator core having the coil wound therearound to the first salient pole 311a.

Then, the magnetic flux flows toward the rotor pole 60 connecting the first and second rotor disks 610 and 620 to each other.

Next, the magnetic flux passing through the rotor pole 60 connecting the first and second rotor disks 610 and 620 to each other flows in the second stator salient pole 312a.

In addition, when the application of the power to the first coil is stopped and the power is applied to a second coil wound between the second and third salient poles 312a and 313a, similar to the above-mentioned method, a magnetic flux f2 shown in a dotted line flows in the second stator salient pole 312a, the rotor pole 60 connecting the second and third rotor disks 620 and 630 to each other, and the third salient pole 313a, as shown.

Next, when the application of the power to the second coil is stopped and the power is applied to a third coil wound between the third and fourth salient poles 313a and 314a, to similar to the above-mentioned method, a magnetic flux f3 shown in a dotted line flows as shown.

Therefore, according to another preferred embodiment of the present invention, the transverse switched reluctance motor including the stator 300a uses a scheme of applying the power only to a single coil rather than a scheme of simultaneously applying the power to each of the coils wound around the stator 300a.

As set forth above, according to the preferred embodiments of the present invention, a transversal magnetic flux moving in parallel with the shaft is added to a magnetic flux path to make the magnetic flux path short, thereby making it possible to reduce core loss.

In addition, the rotor and stator that may be stacked in plural and be easily extended are provided, thereby making it possible to improve driving force of the transverse switched reluctance motor.

Further, the transverse switched reluctance motor is set-modularized, thereby making it possible to extend the transverse switched reluctance motor so as to be appropriate for the magnitude of a torque demanded by a component having the transverse switched reluctance motor mounted therein.

Although the preferred embodiments of the present invention have been disclosed for illustrative purposes, they are for specifically explaining the present invention and thus a transverse switched reluctance motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A transverse switched reluctance motor comprising:
a rotor including a plurality of rotor disks each having a shaft fixedly coupled to an inner portion thereof, having a plurality of rotor poles fixedly coupled thereto along an outer peripheral surface thereof, and arranged in a direction of a shaft; and
a stator assembly including a plurality of stators each facing the plurality of rotor poles, having coils wound therearound, and arranged in a circumferential direction of the plurality of rotor disks so that the plurality of rotor disks are rotatably received therein,
wherein magnetic flux paths are formed so that magnetic fluxes move in the direction of the shaft by the plurality of stators and the plurality of rotor poles facing the plurality of stators to circulate the stators.

2. The transverse switched reluctance motor as set forth in claim 1, wherein the stator is formed by stacking a plurality of stator cores so as to face the rotor disks in a direction in which the rotor disks are stacked.

3. The transverse switched reluctance motor as set forth in claim 2, wherein the stator core includes:
a stator core body disposed at an outer side of the rotor disk and being in parallel with the rotor pole;
a first stator salient pole bent and protruded from one end of the stator core body so as to face an upper surface of the rotor pole; and
a second stator salient pole bent and protruded from the other end of the stator core body so as to face a lower surface of the rotor pole,
the stator core having a C shaped cross section in the direction of the shaft around which the rotor disk rotates.

4. The transverse switched reluctance motor as set forth in claim 3, wherein in the stator, one side of a second stator salient pole configuring one stator core and one side of a first stator salient pole configuring another stator core are coupled to each other, and the other side of the second stator salient pole and one side of a first stator salient pole configuring the other stator core are coupled to each other, such that the stator cores are stacked stepwise.

5. The transverse switched reluctance motor as set forth in claim 4, wherein one stator core and another stator core further include a reinforcing member coupled between outer sides thereof.

6. The transverse switched reluctance motor as set forth in claim 3, wherein the rotor disk is rotatably received in an interval formed by the first and second stator salient poles.

7. The transverse switched reluctance motor as set forth in claim 3, wherein the rotor is configured of the plurality of rotor disks sequentially arranged to be spaced apart from each other at predetermined intervals in the direction of the shaft so that the first stator salient pole or the second stator salient pole configuring the stator core is received therein.

8. The transverse switched reluctance motor as set forth in claim 1, wherein n rotor poles are provided in the rotor disk and are arranged to be skewed, by a predetermined angle difference, from n rotor poles included in another rotor disk disposed to be spaced apart from the rotor disk by a predetermined interval.

9. The transverse switched reluctance motor as set forth in claim 8, wherein the angle difference (θ) corresponds to 120°/n=degree according to the number (n) of rotor poles formed in the rotor disk.

10. A transverse switched reluctance motor comprising:
a rotor including a plurality of rotor disks each having a shaft fixedly coupled to an inner portion thereof, sequentially arranged to be spaced apart from each other at predetermined intervals in a direction of the shaft, and having a plurality of bar shaped rotor poles in parallel with the shaft fixedly coupled thereto along an outer peripheral surface of the plurality of rotor disks; and
a stator assembly including a plurality of stators each facing the plurality of rotor to poles, having coils wound therearound, and arranged in a circumferential direction of the plurality of rotor disks so that the plurality of rotor disks are rotatably received therein,
wherein magnetic flux paths are formed so that magnetic fluxes move in the direction of the shaft by the plurality of stators and the plurality of rotor poles facing the plurality of stators to circulate the stators.

11. The transverse switched reluctance motor as set forth in claim 10, wherein the stator includes:
a stator core disposed at an outer side of the rotor disk and being in parallel with the rotor pole; and
a plurality of stator salient poles protruded from the stator core toward the rotor pole.

12. The transverse switched reluctance motor as set forth in claim 11, wherein the number (m) of stator salient poles is determined according to the number (m) of rotor disks.

13. A transverse switched reluctance motor comprising:
a rotor including a plurality of rotor disks each having a shaft fixedly coupled to an inner portion thereof, sequentially arranged to be spaced apart from each other at predetermined intervals in a direction of the shaft, and having a plurality of rotor poles fixedly coupled thereto along an outer peripheral surface of the plurality of rotor disks to be crossed each other to connect one rotor disk with another rotor disk; and
a stator assembly including a plurality of stators each facing the plurality of rotor poles, having coils wound therearound, and arranged in a circumferential direction of the plurality of rotor disks so that the plurality of rotor disks are rotatably received therein,
wherein magnetic flux paths are formed so that magnetic fluxes move in the direction of the shaft by the plurality of stators and the plurality of rotor poles facing the plurality of stators to circulate the stators.

14. The transverse switched reluctance motor as set forth in claim 13, wherein the stator is formed by stacking a plurality of stator cores so as to face the rotor disks in a direction in which the rotor disks are stacked.

15. The transverse switched reluctance motor as set forth in claim 14, wherein the stator core includes:
a stator core body disposed at an outer side of the rotor disk and being in parallel with the rotor pole;
a first stator salient pole bent and protruded from one end of the stator core body so as to face an upper surface of the rotor pole provided in the rotor disk; and
a second stator salient pole bent and protruded from the other end of the stator core body so as to face a lower surface of the rotor pole provided in the rotor disk,
the stator core having a C shaped cross section in the direction of the shaft around which the rotor disk rotates.

16. The transverse switched reluctance motor as set forth in claim 15, wherein in the stator, one side of a second stator salient pole configuring one stator core and one side of a first stator salient pole configuring another stator core are coupled to each other, and the other side of the second stator salient pole and one side of a first stator salient pole configuring the other stator core are coupled to each other, such that the stator cores are stacked stepwise.

17. The transverse switched reluctance motor as set forth in claim 13, wherein the stator includes:
a stator core body disposed at an outer side of the rotor disk and being in parallel to with the rotor pole;
a plurality of stator salient poles bent and protruded from the stator core toward the rotor pole.

18. The transverse switched reluctance motor as set forth in claim 17, wherein the number (m) of stator salient poles is determined according to the number (m) of rotor disks.
